(19) United States
(12) Patent Application Publication
(10) Pub. No.: US 2012/0085832 A1
(43) Pub. Date: Apr. 12, 2012

(54) Method And System For Controlling A Blower Motor

(75) Inventor: Kevin D. Thompson, Indianapolis, IN (US)

(73) Assignee: CARRIER CORPORATION, Farmington, CT (US)

(21) Appl. No.: 13/252,264

(22) Filed: Oct. 4, 2011

Related U.S. Application Data
(60) Provisional application No. 61/389,901, filed on Oct. 5, 2010.

(51) Int. Cl. G05D 23/19

(52) U.S. Cl. 236/74 R; 236/93 R

(57) ABSTRACT

A method of controlling a blower motor including: receiving a requested airflow from a thermostat; accessing an airflow table and determining an airflow closest to the requested airflow; using a location of the airflow closest to the requested airflow in the airflow table to access a control signal value in a control signal table; and using the control signal value to control the blower motor.

### CROSS-REFERENCE TO RELATED APPLICATIONS

This application is a non-provisional application of U.S. Provisional Patent Application No. 61/389,901 filed Oct. 5, 2010, the entire contents of which are incorporated herein by reference.

### BACKGROUND OF THE INVENTION

The subject matter disclosed herein generally relates to air blowers, and in particular to a method and system for controlling an air blower motor.

Heating, ventilation and air conditioning (HVAC) systems typically use a blower driven by a blower motor to supply air through ducts. Systems are typically designed to provide an amount of airflow expressed as cubic feet per minute (CFM) in certain modes. For example, low heat, high heat, cooling and continuous fan may all utilize different airflows. There is a need to simply and efficiently control the blower motor through different modes of operation.

### BRIEF DESCRIPTION OF THE INVENTION

An embodiment is a method of controlling a blower motor including: receiving a requested airflow from a thermostat; accessing an airflow table and determining an airflow closest to the requested airflow; using a location of the airflow closest to the requested airflow in the airflow table to access a control signal value in a control signal table; and using the control signal value to control the blower motor.

Another embodiment is a system for handling air including: a blower; a blower motor; a controller for controlling the blower motor, the controller: receiving a requested airflow from a thermostat; accessing an airflow table and determining an airflow closest to the requested airflow; using a location of the airflow closest to the requested airflow in the airflow table to access a control signal value in a control signal table; and using the control signal value to control the blower motor.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts an exemplary furnace having an evaporator coil;

FIG. 2 depicts an exemplary airflow table and control signal table; and

FIG. 3 is a flowchart of a control process.

### DETAILED DESCRIPTION OF THE INVENTION

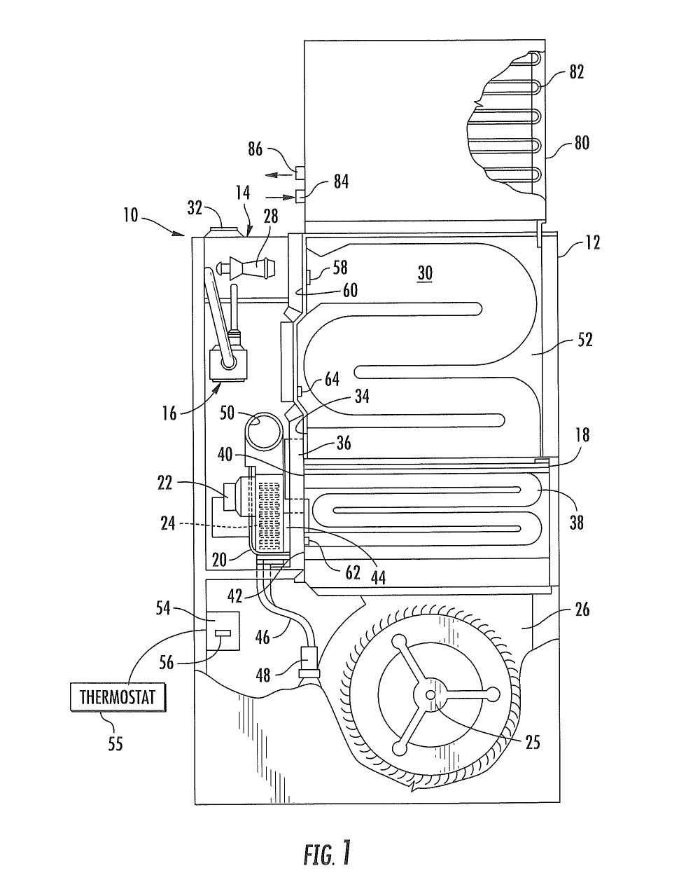

Referring to FIG. 1, the numeral 10 generally designates a gas-fired condensing furnace employing the blower motor control of the present invention. Condensing furnace 10 includes a steel cabinet 12 housing therein burner assembly 14, combination gas control 16, heat exchanger assembly 18, inducer housing 20 supporting, inducer motor 22 and inducer wheel 24, and circulating air blower 26. Combination gas control 16 includes a hot surface igniter (not shown) to ignite the fuel gas.

Burner assembly 14 includes at least one inshot burner 28 for at least one primary heat exchanger 30. Burner 28 receives a flow of combustible gas from gas regulator 16 and injects the fuel gas into primary heat exchanger 30. A part of the injection process includes drawing air into heat exchanger assembly 18 so that the fuel gas and air mixture may be combusted therein. A flow of combustion air is delivered through combustion air inlet 32 to be mixed with the gas delivered to burner assembly 14.

Primary heat exchanger 30 includes an outlet 34 opening into chamber 36. Connected to chamber 36 and in fluid communication therewith are at least four condensing heat exchangers 38 having an inlet 40 and an outlet 42. Outlet 42 opens into chamber 44 for venting exhaust flue gases and condensate.

Inducer housing 20 is connected to chamber 44 and has mounted thereon an inducer motor 22 together with inducer wheel 24 for drawing the combusted fuel air mixture from burner assembly 14 through heat exchanger assembly 18. Air blower 26 is driven by a variable speed blower motor 25 and delivers air to be heated in a counterflow arrangement upwardly through air passage 52 and over heat exchanger assembly 18. The cool air passing over condensing heat exchanger 38 lowers the heat exchanger wall temperature below the dew point of the combusted fuel air mixture causing a portion of the water vapor in the combusted fuel air mixture to condense, thereby recovering a portion of the sensible and latent heat energy. The condensate formed within heat exchanger 38 flows through chamber 44 into drain tube 46 to condensate trap assembly 48. As air blower 26 continues to urge a flow of air, upwardly through heat exchanger assembly 18, heat energy is transferred from the combusted fuel air mixture flowing through heat exchangers 30 and 38 to heat the air circulated by blower 26. Finally, the combusted fuel air mixture that flows through heat exchangers 30 and 38 exits through outlet 42 and is then delivered by inducer motor 22 through exhaust gas outlet 50 and thence to a vent pipe (not illustrated).

Cabinet 12 also houses a controller 54 and a display 56. Controller 54 may be implemented using a microprocessor-based controller executing computer program code stored on a computer readable storage medium. A thermostat 55 communicates with controller 54 to designate operational modes and temperature. Thermostat 55 may be an intelligent device that communicates requested air flow rates as described in further detail herein. A pressure tap 58 is located at primary heat exchanger inlet 60, a pressure tap 62 is located at condensing heat exchanger outlet 42 and a limit switch 64 is disposed in air passage 52. In a non-condensing furnace, pressure tap 62 would be disposed at primary heat exchanger outlet 34, since there would be no condensing heat exchanger 38.

A cooling coil 82 is located in housing 80 on top of furnace cabinet 10 and is the evaporator of air conditioning system. The cooling coil 82 has an inlet 84, where subcooled refrigerant enters, and an outlet 86, where superheated refrigerant leaves, as is conventional. In response to an input from heating/cooling thermostat, air blower 26 urges air flow upwardly through cooling coil 82 where heat exchange takes place. As a result of this heat exchange, cool air is delivered to the conditioned space and superheated refrigerant is returned to the outdoor condensing section (not illustrated) via outlet 86. In the outdoor condensing section the refrigerant is subcooled and returned to inlet 84. This cycle continues until the thermostat is satisfied.

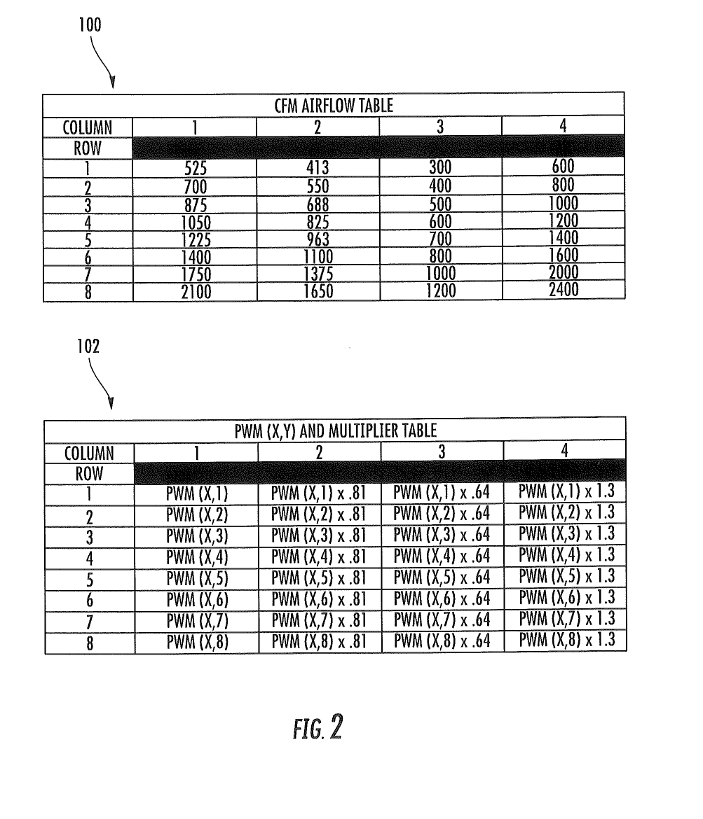

In operation, the controller 54 controls blower motor 25 by providing a control signal to the motor. The control signal may be a pulse width modulated (PWM) signal indicating a duty cycle for blower motor 25. In exemplary embodiments, the control signal is a 12-bit PWM control signal. It is understood that analog control signals may be used, or different types of digital codes may be used to provide the control signal. Controller 54 maintains tables to map the requested CFM to a control signal, as represented in FIG. 2.

The CFM airflow table 100 in FIG. 2 includes airflow values for four different operating modes, shown as columns 1-4. Column 1 may be standard mode (e.g., 350 CFM/ton), column 2 may be a dehumidifying mode (e.g., 275 CFM/ton), column 3 may be a super dehumidifying mode (e.g., 200 CFM/ton) and column 4 may be a maximum mode (400 CFM/ton). When communicating thermostat 55 requests a certain airflow and a certain mode, controller 54 accesses the CFM airflow table 100 and locates the closest airflow value to the requested airflow. The controller 54 records the row and column of the airflow value closest to the requested airflow.

Controller 54 then accesses the control signal table, a PWM and Multiplier table 102, to find the appropriate control signal value. The table location (i.e., row and column) from the CFM airflow table is used to map to a cell in the PWM and Multiplier table 102 to retrieve a control signal value (e.g., a PWM value) and a multiplier, which varies depending upon the mode selected. As shown in the embodiment of FIG. 2, eight PWM values are used along with three multipliers. This allows 32 control signals to be generated by storing only eight PWM values.

Thermostat 55 allows a user to also specify a restriction multiplier that is used to adjust the control signal. During initial installation or maintenance, as user (e.g., installer) can access a menu through thermostat 55 to set a restriction multiplier for one or more modes of operation. The restriction multiplier is used to compensate for varying degrees of duct restriction. In an exemplary embodiment, the restriction multiplier ranges from 1 to 1.5. The user specifies the restriction multiplier using a slide bar on thermostat 55. Controller 54 then applies the restriction multiplier as described herein.

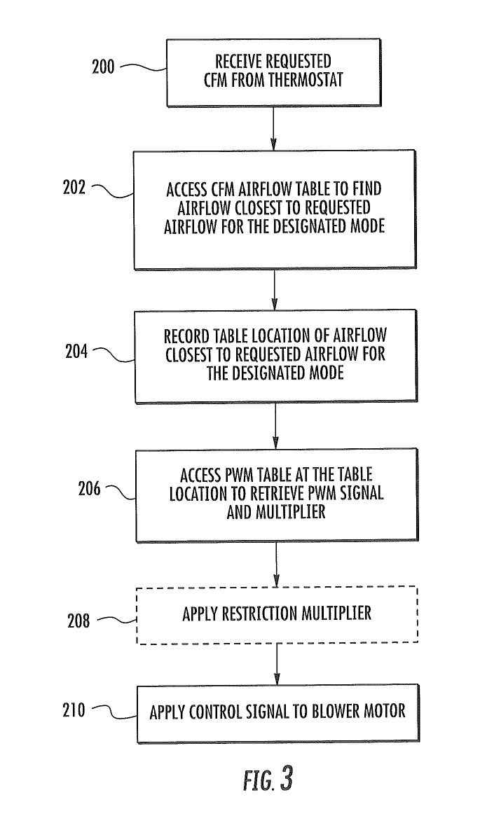

FIG. 3 is a flowchart of an exemplary process executed by controller 54 to control the blower motor 25. The process begins at 200 where the controller 54 receives a requested airflow (e.g., in CFM) from the thermostat 55. At 202, the controller 54 accesses the CFM airflow table 100 and locates the airflow value in the table closest to the requested airflow. At 204, the controller 54 records the table location (e.g., row and column) of the airflow value closest to the requested airflow. At 206 the controller 54 accesses PWM table 102 at the same table location to retrieve a control signal value in the form of a PWM signal and multiplier. At 208, the controller applies the optional restriction multiplier. At 210, the controller applies a control signal to the blower motor 25 in response to the control signal value, the multiplier (if any) and the restriction multiplier (if any). The controller 54 multiplies the control signal value by the multiplier (if any) from the control signal table and by the restriction multiplier (if any). The result is used to generate a control signal for the blower motor 25.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of controlling a blower motor comprising:
receiving a requested airflow from a thermostat;
accessing an airflow table and determining an airflow closest to the requested airflow;
using a location of the airflow closest to the requested airflow in the airflow table to access a control signal value in a control signal table;
using the control signal value to control the blower motor.

2. The method of claim 1 wherein:
the requested airflow is expressed in cubic feet per minute.

3. The method of claim 1 wherein:
the location in the control signal table includes the control signal value and a multiplier.

4. The method of claim 3 wherein:
using the control signal value includes modifying the control signal value by the multiplier.

5. The method of claim 3 wherein:
the multiplier is dependent upon an operating mode specified at the thermostat.

6. The method of claim 5 further comprising:
multiplying the control signal value by a restriction multiplier prior to using the control signal value to control the blower motor, the restriction multiplier being a user defined multiplier set at the thermostat.

7. The method of claim 1 further comprising:
multiplying the control signal value by a restriction multiplier prior to using the control signal value to control the blower motor, the restriction multiplier being a user defined multiplier set at the thermostat.

8. A system for handling air comprising:
a blower;
a blower motor;
a controller for controlling the blower motor, the controller:
receiving a requested airflow from a thermostat;
accessing an airflow table and determining an airflow closest to the requested airflow;
using a location of the airflow closest to the requested airflow in the airflow table to access a control signal value in a control signal table; and
using the control signal value to control the blower motor.

9. The system of claim 8 wherein:
the requested airflow is expressed in cubic feet per minute.

10. The system of claim 8 wherein:
the location in the control signal table includes the control signal value and a multiplier.

11. The system of claim 10 wherein:
using the control signal value includes the controller modifying the control signal value by the multiplier.

12. The system of claim 10 wherein:
the multiplier is dependent upon an operating mode specified at the thermostat.

13. The system of claim 12 further comprising:
the controller multiplying the control signal value by a restriction multiplier prior to using the control signal value to control the blower motor, the restriction multiplier being a user defined multiplier set at the thermostat.

14. The system of claim 8 further comprising:
the controller multiplying the control signal value by a restriction multiplier prior to using the control signal value to control the blower motor, the restriction multiplier being a user defined multiplier set at the thermostat.
